(19) United States
(12) Patent Application Publication
(10) Pub. No.: US 2010/0162306 A1
(43) Pub. Date: Jun. 24, 2010

(54) USER INTERFACE FEATURES FOR INFORMATION MANIPULATION AND DISPLAY DEVICES

(75) Inventor: Michael L. Craner, Exton, PA (US)

Correspondence Address: ROPES & GRAY LLP, PATENT DOCKETING 39/361, 1211 AVENUE OF THE AMERICAS, NEW YORK, NY, 10036-8704, US

(73) Assignee: Guideworks, LLC, Radnor, PA (US)

(21) Appl. No.: 12/582,496

(22) Filed: Oct. 20, 2009

Related U.S. Application Data
(63) Continuation of application No. 11/329,329, filed on Jan. 9, 2006, now abandoned.
(60) Provisional application No. 60/642,307, filed on Jan. 7, 2005.

(51) Int. Cl. H04N 5/445; G06F 3/01

(52) U.S. Cl. 725/39; 715/719

(57) ABSTRACT

Systems and methods are provided for improving the market appeal and/or usability of information manipulation and/or display devices (IMDDs).

This application is a continuation of U.S. patent application Ser. No. 11/329,329 filed Jan. 9, 2006, which claims the benefit of U.S. provisional application No. 60/642,307, filed Jan. 7, 2005, the disclosures of which are hereby incorporated by reference in their entireties.

### FIELD OF THE INVENTION

The present invention relates to user interfaces.

### BACKGROUND OF THE INVENTION

As computing-power and information storage density increases with advances in areas including microelectronics and organic computing, and as the capabilities of information (e.g., multimedia) manipulation and/or display devices (e.g., computers, multimedia-interaction products, personal digital appliances, game machines, cell phones, and three-dimensional video displays) continue to grow, the importance of the usability, realism, and market appeal of such devices becomes paramount.

### SUMMARY OF THE INVENTION

Problems in the prior art are addressed in accordance with principles of the present invention by method and mechanisms that improves the market appeal and/or usability of information manipulation and/or display devices (IMDDs).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 shows a known media player;

FIG. 2 shows a graphically enhanced media player according to an embodiment of the invention;

FIG. 3 contrasts a known media player to a graphically enhanced media player according to an embodiment of the invention;

FIG. 4 shows media playing having a virtual border according to an embodiment of the invention;

FIG. 5 shows an illustrative apparatus according to an embodiment of the invention;

FIG. 6 shows an example of a known shadow effect;

FIG. 7 shows an example of a shadow effect according to an embodiment of the invention;

FIG. 8 shows another example of shadow effect according to an embodiment of the invention; and

FIG. 9 shows an example of displaying icons with varying degrees of plumpness according to an embodiment of the invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

Multimedia Objects Affect the Graphical User Interface

In the prior art, there are various examples of virtual objects, such as multimedia players (e.g., the Windows media player from Microsoft, the Quicktime player from Apple, and the Divx playa from the DivX consortium) and other windowed user-interfaces and virtual on-screen devices that have a graphical representation on the screen of a computer or other IMDD. These virtual objects employ various techniques (e.g., 3D shading, metallic colors, buttons, dials, shadowing, and virtual LEDs) to make them appear more interesting and realistic (e.g., more like actual, tangible, physical objects). On some of these virtual objects, buttons can be pressed, and the shadowing is adjusted to reflect the depression of the button. On others, a technique known as “skinning” is sometimes used to provide a user with some control of the colors and shapes of certain players (e.g., WinAmp). Progressive shading, highlighting, and related techniques are used to display contours and surface textures and depths.

However, the prior art lacks user interfaces where the displayed virtual object (e.g., quicktime player) is affected by the content that it plays or the environment outside the object in a real and dynamic way.

For example, the “metallic-looking” border of a multimedia player of the present art does not optically reflect video content that it plays. However, if the player were a real physical object with a real physical metallic border, the light from the video window would be reflected off that border, in a dynamic fashion, the way it does, for example, off an actual physical border of a TV or computer screen. Thus, the multimedia player of the prior art lacks a degree of realism. In one embodiment, the invention is a windowing technique for a visual display device.

Thus, one embodiment of the present invention is a graphical border for a multimedia (e.g., video) display where the border is rendered in a way such that visual content within the border affects the display of the border. In one example of this invention, the border is rendered as a metallic/reflective frame around a video display window. A viewer location is assumed (e.g., centered in front of the display window at a nominal viewing distance to a screen upon which the window is presented to the viewer). In this example, visual objects within the display window are processed (e.g., ray traced with respect to the assumed viewer location) to dynamically affect the rendering of the window border. In one variation of the above embodiment, the viewer's actual location is used in the processing of the reflections to improve the realism of the reflections off the surface of the border.

In another variant of the above embodiment, the invention is a mechanism that takes aspects (e.g., the spatial luminance over time) of displayed multimedia objects and uses those aspects to affect characteristics of virtual players that are used to display those objects. Objects, as defined herein, are intended to carry, at a minimum the breadth of objects implied by, for example, the MPEG-4 visual standard (e.g., audio, video, sprites, applications, VRML, 3D mesh VOPs, and background/foreground planes). More information on the MPEG-4 visual standard can be found in International Standards Organization Standard ISO/IEC 14496-2:2004.

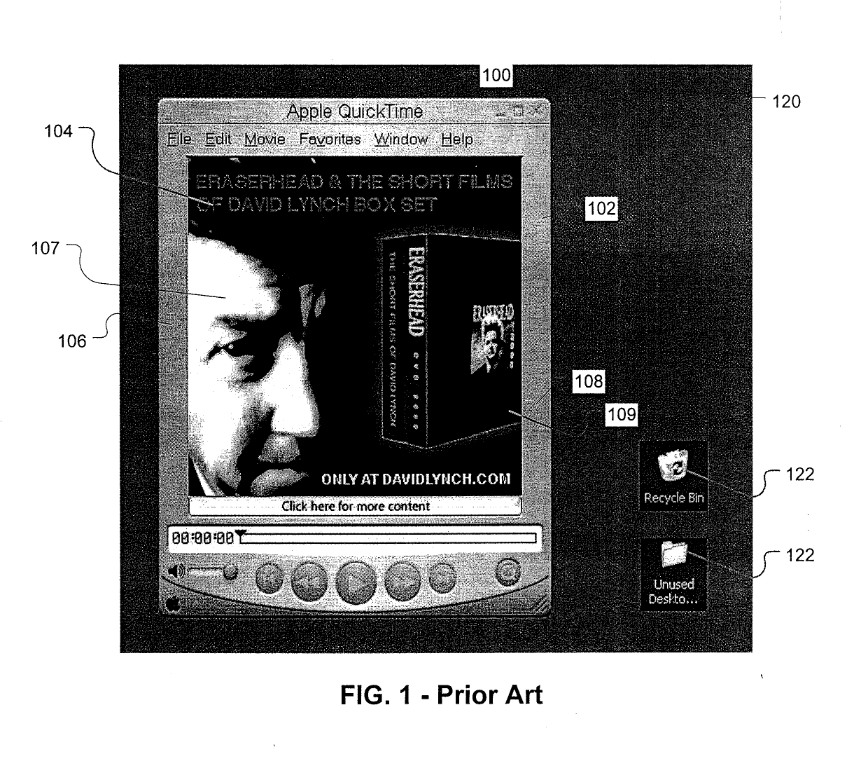

As an example of the problem, and the solution provided by the present invention, consider a multimedia player of the present art (e.g., the quicktime player per FIG. 1) for displaying video on a computer screen. The rendered graphical representation of the player includes a brushed-aluminum border surrounding the video window. This border is statically highlighted in such a way as to provide a degree or physical realism to the border/player. However, the implementation falls short of the realism that could be realized in a number of ways.

If the brushed aluminum border were, in fact, physical, it would reflect light back to the viewer, and those reflections would change dynamically as the ambient light conditions changed in the room of the viewer and/or on the screen surface surrounding the rendered player (and also, in the most realistic implementations, as the viewers perspective with respect to the player changed). The reflections would also change in response to changes to the video content displayed within the dynamic video window within the quicktime player. As illustrated by FIG. 1, the multimedia player 100 is displayed on IMDD screen 120 and exhibits static border 102, and visual display area 104. Note that region 106 of border 102 of the player that is proximate to the brighter region 107 of the visual display area of the player is substantially the same brightness and texture as the region 108 of the border that is proximate the darker region 109 of the visual display. Note also that screen icons 122 are also not affected (even virtually) by light emanating from the visual display.

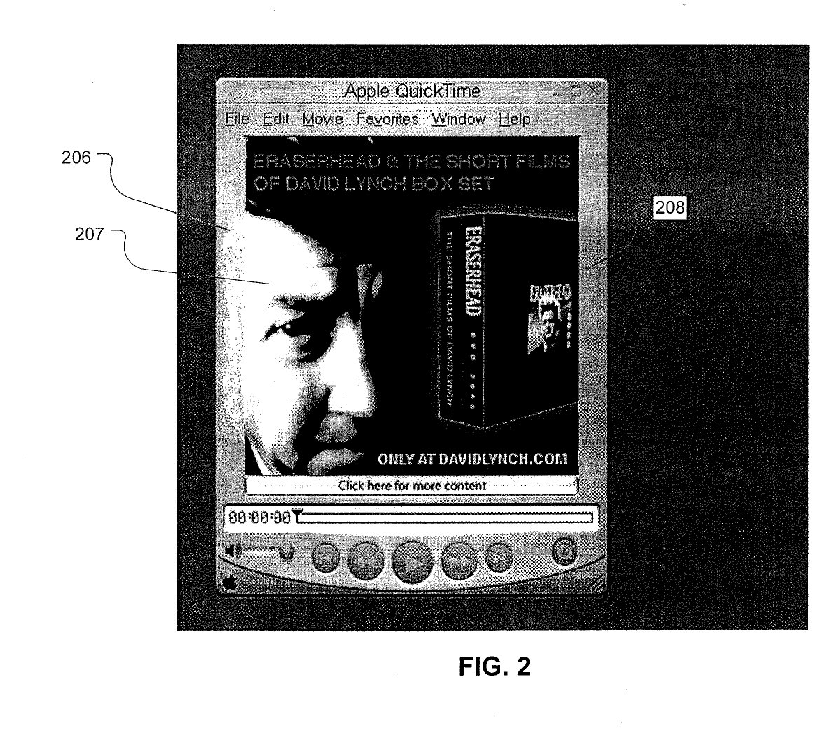

Thus, one example of the present invention is a more realistic virtual player that makes use of ray tracing and related graphical techniques to dynamically change the elements (e.g., borders, virtually raised buttons, contoured surfaces) of the player in response to the content that the player is displaying to create a more realistic rendering of the player. Thus in the present invention, in response to the visual display, the borders of the multimedia player might look, for example, like those illustrated in FIG. 2, where the left region 206 of the border is slightly lighter than the right region 208 of the border, as a function of the greater brightness of the visual display 207, on the left of the visual display. FIG. 2 illustrates just a snapshot of a video sequence. In the present invention, as the light (and color) varied across the screen in an actual video sequence, the rendering of the border would be adjusted correspondingly to reflect the dynamics of the changes in the luminosity and chromaticity of the sequence of images over time.

Another example of the present invention is a more realistic virtual player that makes use of ray tracing and related graphical techniques to dynamically change the elements (e.g., borders, virtually raised buttons, contoured surfaces) of the player in response to ambient light conditions sensed by the physical IMDD upon which the virtual player is displayed.

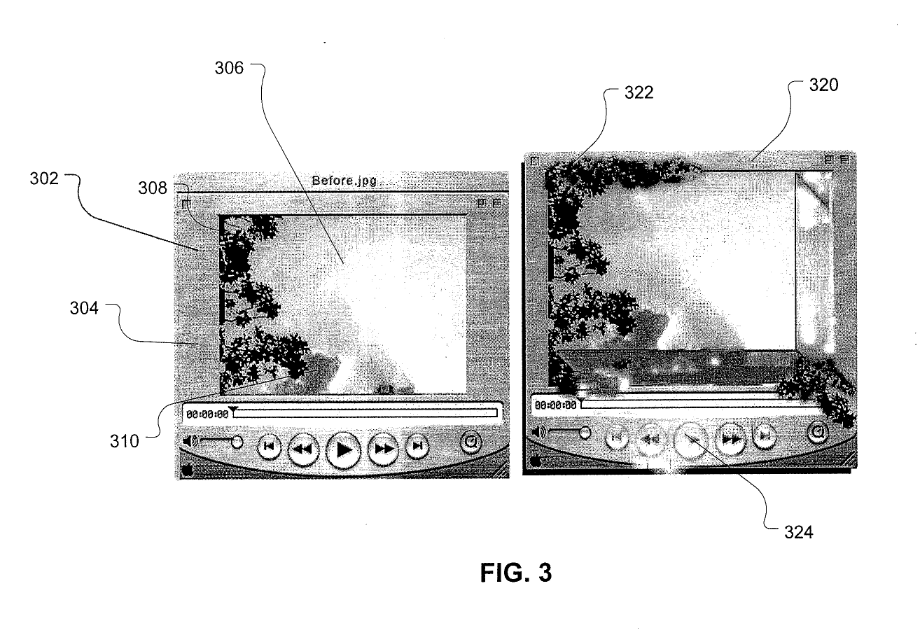

Another example of the present invention is illustrated by the before and after views of a quicktime player depicted in FIG. 3. In the before view 302, a quicktime player according to the prior art is depicted. It includes static border 304 and visual display area 306 that includes video sequence element including foliage 308 and clouds 310. In the after view 322, the rendering of the player has been enhanced according to the present invention wherein the foliage and clouds now extend beyond the visual image to appear to become part of (i.e., interact with) the player (e.g., the foliage starts to grow 322 on the border of the player) or even 324 extend outside of the player (e.g., the clouds tumble out of the screen, over the border of the player and might even invade the rest of the computer screen).

In certain embodiments of the present invention, the perspective of the viewer can additionally be either sensed (e.g., by a camera that is adapted to track the viewer, or by physical sensors attached to the display or viewer seating area) or assumed dynamically, and the elements of the player are changed in response to this sensed or assumed perspective.

Note that the invention is not limited to application to a player with a border that surrounds a multimedia object display window. The latter is just one example of a virtual object on a IMDD display. Other examples relevant to the present invention include any type of on-screen display (OSD) provided by a graphical user interface (GUI) in a set-top box (e.g., a DCT6412 dual-tuner digital video recorder from Motorola Corporation of Chicago, Ill.), station identification bug provided by a broadcaster in the lower right hand region of a TV screen, a menu provided at the top of a computer screen, a button or icon located on a TV screen or computer screen, a flip bar for an electronic program guide on a TV screen, an entire EPG (opaque or semi-transparent), or any graphical or multimedia object that is intended to emulate a physical object on a display.

Note that, although an objective of the present invention is enhanced realism, another goal is market appeal. In some cases these objectives are orthogonal. Thus, it is not necessary under the present invention that the rendering be highly accurate or even “realistic.” Rather, any approximation to dynamic affect of the multimedia object on its player (even if crude) would be within the scope of the present invention as long as it achieves the objectives of favorably differentiating the display from existing devices.

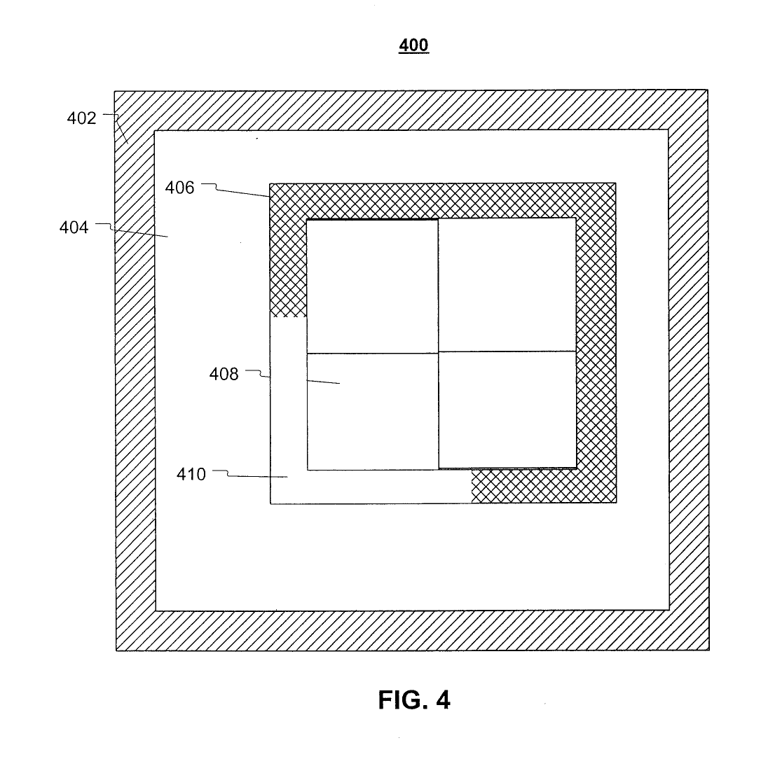

For example, one low complexity implementation of the present invention with respect to a multimedia player would involve (a) regularly sampling a set of representative pixels from a video display, (b) calculating the average luminance of the set by performing a 2D averaging of the luminance components of the pixels in the set, and (c) using the average luminance at each sample time to adjust the relative brightness/lightness (e.g., approximating reflection of the visual content) of the border of the multimedia player. A higher complexity implementation (see FIG. 4) could divide the video display into four regions, average within each region, and use the luminance average for each region to adjust the brightness of the proximate border section (optionally using a distance or distance squared attenuation of the effect).

FIG. 4 illustrates IMDD display 400 having physical border 402, screen 404, virtual multimedia player having virtual border 406 and video display window inside border 406. The display has been logically divided into four regions for illustration purposes. In the actual device, the video window would continue to display the video sequence.

Illustratively, FIG. 4 shows that quadrant 408 of the video display window was calculated by the present invention to have a higher luminance than the other three regions. Correspondingly, the section 410 of the border of the virtual player device is lightened to reflect the brighter video proximate to that section of the border.

Higher complexity implementations would be understood to those skilled in the art including those involving finer resolution of intensity averaging calculations all the way up to where luminance and chrominance effects on the graphical object (e.g., border) are calculated as a function of each pixel. Also, calculation of proper angles and reflections via ray tracing for proper perspective, and other related techniques can be used as would be understood to one skilled in the art.

Other examples of the present embodiment of the invention are listed below:

1. An EPG flip bar that is overlaid on a video sequence (via a graphics engine in a set-top box) where the rendering of the flip bar is dynamically affected by the content of the video sequence. Consider a flip bar in the shape of a metallic horizontal cylinder with EPG rendered onto the surface. The metallic surface would “reflect” the video to the viewer, with appropriate transformations made to the reflection corresponding to the curvature of the cylinder.

2. A picture-in-picture (PIP) border or picture-in-graphic (PIG) where the border (in the PIP case), or the graphic (in the PIG case) rendering is dynamically affected by the displayed video sequence.

3. A graphical object on a TV screen whose rendering is dynamically affected by a specific multimedia object of interest (e.g., one specific video object layer) within a multi-object multimedia object (e.g., an MPEG-4 composite video sequence). For example, as discussed, in some of the previously discussed embodiments of the present invention, a border on a window displaying an explosion scene in a video might lighten during the explosion sequence. However, in the present embodiment, for example, the border of a player is might not be affected by the explosion but instead only change in response to the position of one particular object of interest (e.g., a superhero) in the explosion sequence. In another example of this embodiment, in a soccer game, the soccer ball could be artificially considered to have a high “brightness” (e.g., importance). Thus, the border of a virtual player around this video could accentuate the location of the soccer ball through time without being affected by the rest of the scene. This is an example where the effect of the visual sequence on the border does not necessarily improve the realism of the display but rather the functionality and/or “cool” factor of the display.

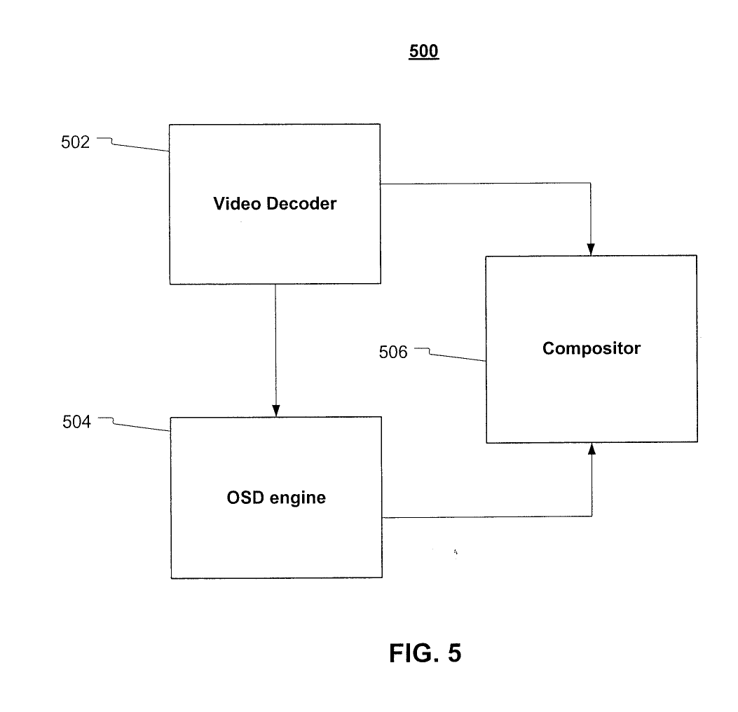

FIG. 5 depicts exemplary apparatus (e.g., part of the hardware/software in a set-top box) 500 according to the present invention. It includes video decoder (e.g., MPEG-2 or MPEG-4 visual decoder) 502, on-screen display engine (e.g., graphics engine, processor, associated hardware) 504, and compositor 506.

In operation, video decoder 502 receives and decodes a video stream that potentially includes some descriptive information about the structure of the stream (e.g., object layer information or 3D object description information in the case of an MPEG-4 stream) in addition to the coded texture for the elements of the video sequence. OSD engine 504 processes requests from a user and also receives information about the video stream from the video decoder, in some cases including rendered objects in a frame buffer format, and optionally content description information (e.g., MPEG-7 content description) that is correlated with the video and may be part of the same video transport stream as the video or part of a separate stream provided to the OSD engine, for example, over the Internet. The OSD engine can use information from the video stream or content information to modify the user interface before sending it to compositor for compositing into a visual frame for display (e.g., by a monitor).

In cases as described in the following section, where the user interface affects or interacts with the rendering of the video objects, information or controls can be sent from the OSD engine to the video decoder (affecting which objects get decoded or the spatial location, visibility, transparency, luminance and chrominance of video objects. Alternatively, the OSD can request that certain video objects instead be sent to the OSD engine from the decoder and NOT to the compositor. The OSD engine then modifies these objects before sending them, along with other graphical objects (e.g. created by the OSD engine and which represent aspects typically of the OSD) to the compositing engine for compositing.

User Interface Interacts or Affects Rendering of Multimedia Objects

The flip side of the above embodiments of the present invention, where the multimedia objects have a dynamic effect on the rendering of the user interface, is where the user interface dynamically affects the rendering of the multimedia object(s). The following example should help illustrate the concept.

In the prior art, it is common to have a graphical object (e.g., part of the user interface) appear to cast a shadow over, for example, a region of a computer screen under (from a chosen light source and viewer perspective that is typically not coincident) the graphical object. However, the present invention goes beyond this concept to have the graphical object (part of the user interface) appear to be part of (affect or interact with) the actual multimedia object (e.g., video).

As an example, again consider an EPG “flip bar” that pops up across the bottom of a video screen. In the present art, such a flip bar might at best have a 3D-shadow-box effect associated with it. The shadow-box is designed to make the flip bar appear to float slightly above the video screen. However, this is a limited effect that assumes the location of a virtual light source and limits the “shadow” to a homogenous color/texture partial border around the flip bar that does not interact in any way with the underlying video.

In the present invention, however, a flip bar would actually interact with or affect the presentation of the video by shadowing, for example, differently across different video objects in the video scene, dynamically, based on their color and luminance. This can be accomplished in a number of different ways, as would be understood to one skilled in the art, and some implementations are provided some additional support in the context of object based video, such as that supported by the MPEG-4 visual standard.

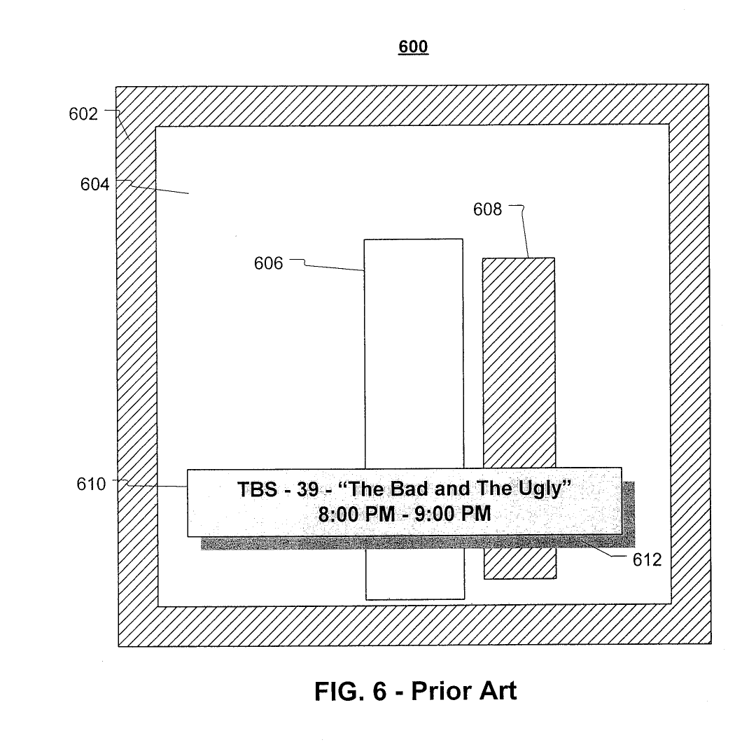

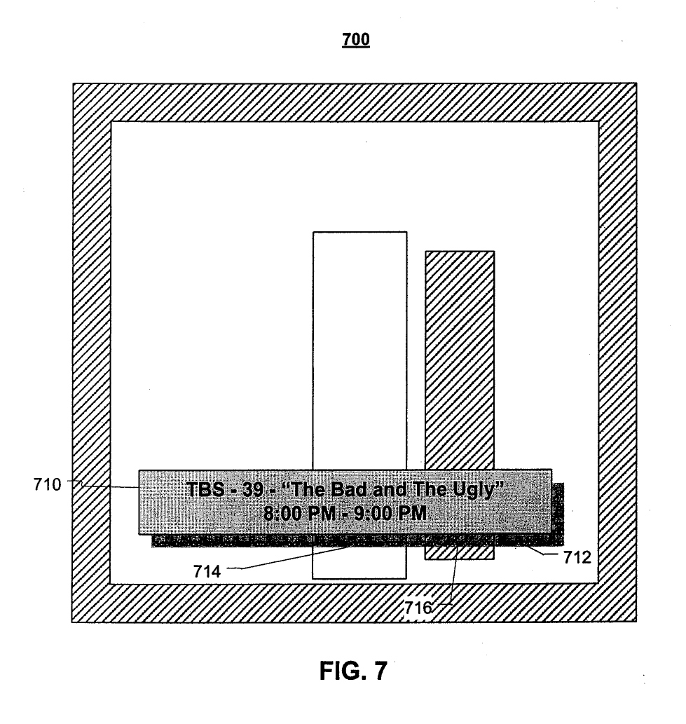

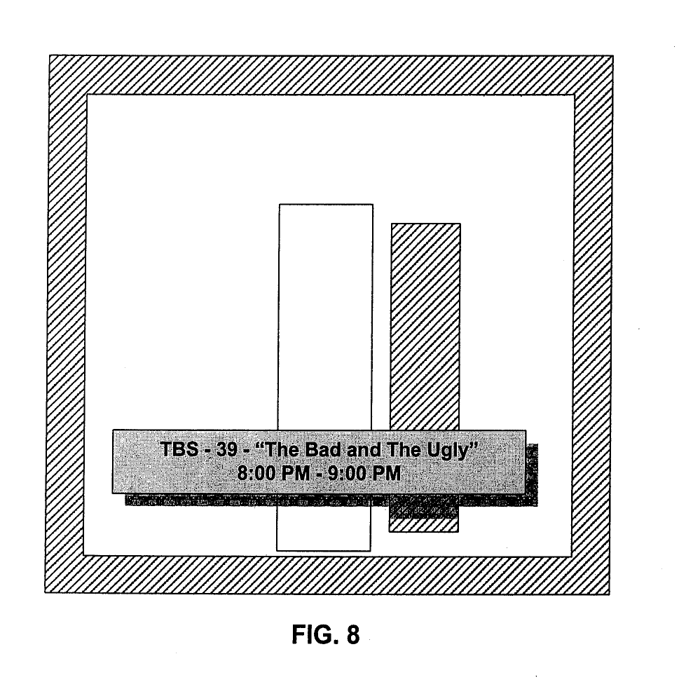

FIGS. 6, 7, and 8 help illustrate the above example. FIG. 6 includes a display 600 (e.g., TV or IMDD monitor/LCD) with border 602, and screen region 604. Each also illustrates a video playing on the screen region where the video includes white foreground building 606 and cross-hatched background building 608, where the cross-hatched building is smaller to illustrate (by perspective of the video that is playing) that it is farther away in the video scene. FIG. 6 further includes flip bar 610, shadow effect 612 and video scene objects 606 and 608 (e.g., white and cross-hatched buildings that are part of the video being played). Note that FIGS. 7 and 8 include a similar display, border, screen region, and buildings, as shown in FIG. 6. Note that in FIGS. 6, 7, and 8, an attempt is made to illustrate the effect of shadowing different objects in the content differently based on their distance from the virtual object that overlays the display of the content. Though the illustrations may have limited accuracy in representing this, the idea is that in an actual implementation, proper artistic properties of perspective, shadowing, the dispersion of light and other effects would be considered to render the scene with the appropriate effect.

FIG. 6 illustrates a flip bar and shadow effect 612 of the prior art. Even though the flip bar's shadow is cast over objects in the video scene with different luminances (and potentially color/reflectivity), the shadow effect is homogenous in color/intensity/texture and has no interaction with the actual content of the video scene over which it is cast.

Contrast this with the flip bar 710 and shadow 712 of an example of the present invention as illustrated by FIG. 7. IMDD 700 of FIG. 7 has similar elements to IMDD 600 of FIG. 6. However, in the present invention, the shadow effect is different as a function of objects within the video scene. In other words, the graphical object (e.g., flip bar) affects the display of the multimedia content. Notice that shadow effect 714 over the white building is different that shadow effect 716 over the cross-hatched building. One approximate way to implement this effect in the present invention is by using a degree of transparency on the shadow effect. Transparency is well known in the art as are interfaces which use semi-transparent graphical overlays so that the underlying subject matter is still partially visible, however, the concept of affecting or interacting with the video is new as will become more clear from the next example.

To appreciate the scope of the present invention, it is not so important to recognize that the shadow effect of the present invention is better or more realistic than the prior art, but it is important to recognize that in the present invention, the user interface interacts or affects the video being displayed in ways that are novel and interesting.

To appreciate the meaning of “affects or interacts with” the multimedia content, consider the two buildings in the video, where, as described earlier the white building is closer than the cross-hatched building (at least they were arranged that way in the video when they were shot). If the flip bar were actually in the video, for example, if during the filming of the video, a physical flip bar were placed in front of the buildings, it would cast a shadow on the buildings but the shadow would vary in not just texture, but also in shape. This is illustrated by the FIG. 8 which illustrates how the shadow is projected along a line from an assumed location for a point of illumination which casts the shadow to the white and cross-hatched buildings. Note that the shadow cast on the cross-hatched building has a shadow line that is lower than that cast on the white building. This is because the shadow “should” be lower on the object that is further, because the projection of the shadow is extended.

Again, it is not so much that the shadow is true to life, but rather that characteristics of the multimedia content were used in calculating the projection of the shadow box of the graphical object (flip bar in this example). In other words, the graphical object interacts with the video content to affect the display of the video objects within the scene.

For visualization and appreciation of the dynamics, think of a video sequence where a plane is flying low over some mountains and the viewpoint is from the plane or just above the plane such that the shadow of the plane can be seen on the mountains below. Note that the shadow of the plane jumps back and forth, up and down as the depth of the mountains below changes. The plane and the mountains are all part of the video sequence. Consider, however, the present invention. Think now of the flip bar replacing the plane or overshadowing the plane from the video. In one embodiment of the present invention, when a flip bar is popped up on the display, it will cast its shadow on the mountains in the same way the plane did, the shadow bouncing up and down as if the flip bar were itself flying over the mountains.

As another example, consider a video scene that includes a mirror. True to the present invention, when the flip bar pops up, the mirror in the scene would reflect the flip bar back to the viewer providing an interesting feeling of the flip bar being somehow a part of the actual video, or in another sense, the video itself becomes more real and the flip bar appears to be more like a real physical object as opposed to just a graphical overlay.

Again, as mentioned before, some of these things are more difficult than others to implement in the present state of the art of video. However, consider MPEG-4 visual video streams that can include multiple object planes where, for compositing purposes, at a minimum, the ordering (which implies a relative depth) of the video object layers is provided. In one embodiment of the present invention a compositing engine (e.g., in an IMDD supporting MPEG-4 visual) is interfaced with a user-interface graphics engine in the IMDD and the UI makes use of information in the MPEG-4 scenes description to calculate flip bar and shadow effects. These shadow effects are sent back to the compositing engine where they are composited and therefore affect or “interact” with the scene.

In another related embodiment, when encountering 3D mesh objects in the MPEG-4 scene, for example, the compositing engine sends specifics about the objects to the graphics engine, the graphics engine calculates how the graphical element(s) of the UI should interact with the scene and it feeds information back to the compositing engine to affect the display of the 3D objects.

As another example, consider a situation where the designer of the flip bar wants to make it “luminous.” In other words, the flip bar or any other element of the graphical user interface (even the channel bug) could itself be a source of light, perhaps a bright source of light. In this case, an example of the present invention is where this graphical object does not cast a shadow on the scene, but rather illuminates the video scene. Again, various degrees of complexity can be applied in the implementation of this example of the present invention.

In one implementation, the light of the graphical object is projected in R̂2 manner to pixels of the video scene. The luminance of those pixels closest to the graphical object is increased. Possibly, the luminance of those pixels further from the object can be decreased. If the graphical object includes chrominance, the chrominance can also be used to change the chrominance of pixels in the video scene, again using a proximity function where closer pixels are affected to a greater extent than further pixels. In a variation of this embodiment, black regions of a video scene are assumed to be for example, background areas and thus further away, and thus less affected (due to distance) by the luminosity of the graphical object. A threshold on luminance can be selected such that those pixels below a certain luminance threshold (the threshold potentially also a function of distance or a dynamic function of some other scene characteristic (e.g., average scene luminance)) are not changed, while other pixel are adjusted in luminance and chrominance. To clarify the concept, imagine a graveyard scene and a UI with a graphical element glowed a bright red. In the present invention, as the scene panned slowly from left to right, for example, tombstones would be illuminated with an eerie red glow from the graphical element, creating the illusion that somehow, graphical element were in the graveyard as well.

As another example of this type of interaction, consider a video sequence that consists of, for example, a flow from left to right. For ease of visualization, consider a video sequence showing similar to the stampede scene from the movie the Lion King where numerous animals of various sorts are streaming across the screen from left to right. Now imagine a user pops up a graphical object (e.g., some type of virtual control widget for navigating his IMDD). In the prior art, this object would typically opaquely overlay the video scene or at best overlay in a semitransparent manner. In an embodiment of the present invention, however, the graphical object interacts with the elements of the video sequence. So, for example, in this embodiment of the present invention, when a user pops up a graphical widget (for example volume control slider), the present invention would cause the video to be rendered in such a way that it would appear that the animals had been directed to avoid running into the virtual widget. This would look similar to the way the animals streamed around the one branch to which Simba clung in that fateful scene in the Lion King movie during the stampede. Implementations of the above would include interacting with the actual objects of an MPEG-4 multi-object scene or, in the case of a more convention video sequence, using stretching, morphing, and non-linear distortion techniques on the scene to have it flow around the graphical object dynamically as would be understood to one skilled in the art.

In a variant on the above embodiment, an alternative effect can be applied. Here the surface of the video screen is considered to be made of stretch saran wrap, for example, and again using standard projection techniques, the video surface is made to appear to sink in the middle where it is “supporting” the virtual widget. In another variant, when the widget (e.g., flip bar) is flipped up, it creates ripples on the surface of the video sequence as if the surface of the screen was the surface of a pool and the widget was placed down (or even splashed down) onto the video scene.

Large/Fat Icons

This invention is a twist on GUI icons in use in various computer systems and in some TV systems. GUIs have historically used color and texture to improve the usability of the UI. Consider the file manager or “explorer” in Microsoft Windows. In one view, files can be represented as little rectangular icons, and folders as little manilla folders. In icon view the representation of the file implies the application which created the file. In thumbnail view, the representation of a file represents the content of the file (e.g., via a preview of an image within the file, for example).

However, in the present invention, the concept of weight or girth is used to add to the functionality of the user interface by quickly allowing the importance of a file (as represented graphically in terms of the size, weight, girth of the icon for the file). This invention, in a sense follows the American motto of “bigger is better,” or at least bigger is more important.

With all the emphasis there is on dieting these days, it is unlikely that the difference between the size or “plumpness” of file representations or icons in a user interface would go unnoticed.

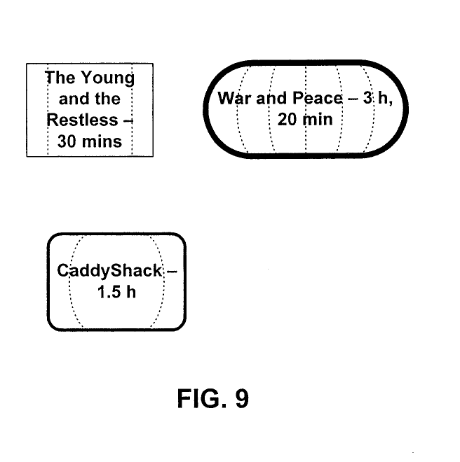

Hence, one embodiment of the present invention is the representation of files with varying degrees of plumpness, the degree of plumpness mapped to a user-selected parameter of importance. For example, if the user would like to see larger files as plumper, he selects a view that maps file sizes to plumpness and then all his files change to a representation where the biggest is the plumpest and the smallest is relatively skinny (see, for example FIG. 9). Note that this can be used as an alternative to a sorting function or in addition to it. For example, you could still sort the files by date as per the prior art, but per the present invention, in the plump=large mode, the user could quickly determine both the newest and largest files at a glance.

FIG. 9 depicts three icons, each representing a system resource. In this case, each system resource is a multimedia object, in particular, a program recording in a personal video recorder, and the parameters of importance are the recorded length of each program. Note that the figure illustrates for each icon the combination of three distinct characteristics to depict plumpness. These characteristics are icon size, line thickness, and bending of the vertical fill lines of the icons to indicate a stretched pants effect.

Note that in other embodiments, the system resources could be storage elements (e.g., miniSD memory cards) associated with, for example, a portable device, and the parameter of importance or interest could be the total size or space remaining on each of those storage elements.

Interestingly, though mapping file size to plumpness is sort of intuitive, the invention is not limited to just mapping file size. Rather, any parameter of a file that is of interest can be mapped to plumpness. “Size matters” in a sense here since plump means “of relative importance” in terms of the mapped parameter.

As another example, in the present invention, the user may decide that older files are “important” to him. He can thus map age (reverse chronological) to plumpness. Then all old files will map to plumpness and be easily identified.

A particularly interesting mapping is “relevance” to plumpness. This is a variant on the theme. In this embodiment, a user selects a “key” file, then selects a “map relevance to plumpness” view. The software then executes a word frequency analysis of all files (e.g., in a directory), then compares then with the key file, calculates a relative match, and then adjusts the plumpness of all iconic representations of the files in the directory to reflect the match.

In various implementations, plumpness of an icon is represented by modifying a simulated context or environment for the icon in a way that conveys plumpness, including, for example, depicting icons as resting on a deformable surface, such as a cushion, and depicting plumper icons as depressing the surface to a greater degree than less plump icons, or depicting icons as hanging from a stretchable support, such as a bungee cord, spring, flexible metal or plastic support structure or related support, and depicting the plumper icons as elongating or bending the elements of the support structure to a greater degree than the less plump icons.

And in other embodiments, plumpness of an icon can be left to the artists eye and can include making personifying the depiction of the icon and making the icon look more plump by, for example, generally making the icon look more curvaceous, rounding the edges of the icon, stretching the icon in the horizontal direction, bending vertical lines of the icon outward from the center of the icon, and/or adding indications of plumpness to the icon such as chubby cheeks, double chin, a pot belly, or a general slump.

Aged Files

Another variant on this invention is using the concept of age, independently, or in conjunction with “plumpness” or “largeness” as described previously. In this embodiment, certain typical visual characteristics of age are used to modify the appearance of standard icons. For example, whiskers, slight asymmetry, a general graying of the icon or around the “temples,” the effects of gravity on the overall shape, and other aspects that would be understood to graphical and cartoon artists can be applied to imply “age” of a file.

The content streams as described herein may be in digital or analog form.

As can be seen by the various examples provided, the invention includes systems where elements of a user interface affect the content that is presented, systems where content that is presented affects elements of a user interface associated with that content presentation, and systems where the user interface elements interact with the content and vice-versa.

Also within the scope of the present invention are systems where elements of the user interface are dynamically correlated with elements of the content and vice versa. As an example, consider an electronic program guide (EPG) on a settop that is playing back a multiple multimedia object presentation of the Wizard of Oz. A user-selectable virtual object (e.g., semi-transparent button) associated with the EPG could be dynamically correlated over time with an object within the content feed such as the tin man, or Dorothy's shoes. This button would allow the user to effectively select a function that is relevant to the tin man or Dorothy's shoes, such as purchasing the song “If I only had a brain,” or ordering a catalog featuring shoes from Kansas. As a related example of altering the content as a function of the user interface, consider the same movie playing back where the user selects the option to highlight Dorothy's shoes or track the tinman over time, as part of, for example, a user convenience feature.

While this invention has been described with reference to illustrative embodiments, this description should not be construed in a limiting sense. Various modifications of the described embodiments, as well as other embodiments of the invention, which are apparent to persons skilled in the art to which the invention pertains are deemed to lie within the principle and scope of the invention as expressed in the following claims.

1. A method for altering the presentation of a plurality of multimedia objects that are displayed by an information manipulation and/or display device (IMDD) as a function of characteristics of a user interface element of the IMDD, the method comprising:
receiving a video comprising the plurality of multimedia objects from a video source, the plurality containing a first multimedia object and a second multimedia object, the first multimedia object at a depth that is different than the depth of the second multimedia object from the perspective of a potential viewer of the IMDD;
invoking a user interface element that is part of a user interface of the IMDD and not in the video, which user interface element is at a depth that is different than the depths of the first and second multimedia objects; and
calculating first and second shadowing effects corresponding to the first and second multimedia objects, wherein the shadowing effects are applied differently to the first multimedia object and the second multimedia object and each shadowing effect is at least a function of the depths of the user interface element and the first and second multimedia objects.

2. The method of claim 1, wherein each shadowing effect is at least a function of the luminance or chrominance attributes of the first and second multimedia objects.

3. The method of claim 1, wherein each shadowing effect is at least a function of the luminance or chrominance attributes of the user interface element.

4. The method of claim 1, wherein at least one of the first and second multimedia objects is a video object.

5. The method of claim 1, wherein the IMDD is a digital settop box and the user interface is an electronic program guide.

6. The method of claim 1, wherein the depth of the user interface element is between the depths of the first and second multimedia objects.

7. The method of claim 1, wherein the perspective of the potential viewer of the IMDD is estimated.

8. The method of claim 1, wherein the potential viewer of the IMDD is an actual viewer of the IMDD and the position of the actual viewer is sensed.

9. A method for altering the trajectory of a multimedia object that is displayed by an information manipulation and/or display device (IMDD) as a function of characteristics of a user interface element of the IMDD, the method comprising:
receiving a video comprising a multimedia object with an associated initial trajectory over time;
invoking a user interface element that is part of a user interface of the IMDD and not in the video, which user interface element is at a position proximate to one or more positions along the initial trajectory of the multimedia object; and
altering the initial trajectory of the multimedia object over time as at least a function of the invoking of the user interface element, the initial trajectory of the multimedia object, and the position of the user interface element.

10. The method of claim 9, further comprising altering a shadowing effect applied to the multimedia object over time as at least a function of the invoking of the user interface element, the initial trajectory of the multimedia object, and the position of the user interface element.

11. The method of claim 9, further comprising altering the luminance or chrominance of the multimedia object as at least a function of the invoking of the user interface element, the initial trajectory of the multimedia object, and the position of the user interface element.

12. The method of claim 9, wherein the multimedia object is a video object.

13. The method of claim 9, wherein the IMDD is a digital settop box and the user interface is an electronic program guide.

14. The method of claim 9, wherein the initial trajectory of the multimedia object would intersect a region occupied by user interface element and the altering the initial trajectory of the multimedia object comprises calculating a trajectory which avoids the region occupied by the user interface element.

15. The method of claim 9, wherein a perspective of a potential viewer of the IMDD is considered when altering the initial trajectory of the multimedia object.

16. The method of claim 15, wherein the potential viewer of the IMDD is an actual viewer of the IMDD and the position of the actual viewer is sensed.

17. The method of claim 9, wherein the multimedia object is a video sequence and altering the initial trajectory over time of the multimedia object comprises warping the video sequence as at least a function of the position of the user interface element.

18. A method for altering the look of a multimedia object that is displayed by an information manipulation and/or display device (IMDD) as a function of characteristics of a user interface element of the IMDD, the method comprising:
receiving a video comprising a multimedia object with an associated initial texture characteristic and a position at a point in time;
invoking a user interface element that is part of a user interface for the IMDD and not in the video, which user interface element is at a position proximate to the position of the multimedia object at the point in time; and
altering the initial texture characteristic of the multimedia object as at least a function of the invoking of the user interface element, the position of the multimedia object, the position of the user interface element and texture characteristics of both the user interface element and the multimedia object.

19. The method of claim 18, wherein altering the initial texture characteristic of the multimedia object comprises:
approximating the propagation of light from the user interface element to the multimedia object;
approximating the reflection of the propagated light from the multimedia object to an estimated location of a potential viewer of the IMDD; and wherein,
altering the initial texture characteristic is at least a function of the two approximations.
